(19) United States
(12) Patent Application Publication
(10) Pub. No.: US 2026/0245171 A1
(43) Pub. Date: Aug. 20, 2026

(54) DISPLAY METHOD AND APPARATUS, ELECTRONIC DEVICE, AND STORAGE MEDIUM

(71) Applicant: Beijing Zitiao Network Technology Co., Ltd., Beijing (CN)

(72) Inventors: Shun HU, Beijing (CN); Bowen YANG, Beijing (CN); Po Yu CHOU, Beijing (CN)

(21) Appl. No.: 18/876,642

(22) PCT Filed: Sep. 14, 2023
(86) PCT No.: PCT/CN2023/118713

§ 371 Date: Dec. 18, 2024

(30) Foreign Application Priority Data
Sep. 19, 2022 (CN) 202211139273.5

(51) Int. Cl. G06T 3/40; G06F 3/14

(52) U.S. Cl. CPC G06T 3/40; G06F 3/14

(57) ABSTRACT

Embodiments of the present disclosure provide a display method and apparatus, an electronic device, and a storage medium. The method comprises: based on a display resolution of the current device, determining an adaptive display unit of a display interface; and based on a ratio relationship between a display object in a page to be displayed and the adaptive display unit, determining an adaptive size of the display object in the display interface, and rendering the display object in the page to be displayed based on the adaptive size of the display object.

The present application claims priority to the Chinese patent application No. 202211139273.5 filed on Sep. 19, 2022 to China National Intellectual Property Administration, the entire contents of which are incorporated by reference into the present application.

### FIELD

The embodiments of the present disclosure relate to a field of communication technology, and more specifically, to a display method and an apparatus, an electronic device, and a storage medium.

### BACKGROUND

Currently, the variety of screen resolutions and screen sizes of terminal products is increasing. For example, the models of terminal products in different countries and regions are highly complex, and APPs (applications) need to be adapted to different models of terminals, which brings a significant amount of repetitive design and production workload to developers. At the same time, the adaptability of pages on different terminals is poor, resulting in inconsistent visual displays.

### SUMMARY

The present disclosure provides a display method and an apparatus, an electronic device, and a storage medium to avoid a situation where the adaptation efficiency of pages in different terminal products is low, to improve the compatibility of pages in the design and production process, and the coordination when displayed on different terminals, thereby improving the adaptation efficiency of interfaces in different terminal products.

In a first aspect, an embodiment of the present disclosure provides a display method. The display method comprises:
determining, in response to a trigger operation for a page to be displayed and based on a display resolution of the current device, an adaptive display unit of a display interface, the adaptive display unit comprising at least one pixel; and
determining, based on a ratio relationship between a display object in the page to be displayed and the adaptive display unit, an adaptive size of the display object in the display interface, and rendering the display object in the page to be displayed based on the adaptive size of the display object.

In a second aspect, an embodiment of the present disclosure further provides a display apparatus. The display apparatus comprises:
an adaptive display unit determining module configured to, in response to a trigger operation for a page to be displayed and based on a display resolution of the current device, determine an adaptive display unit of a display interface, the adaptive display unit comprising at least one pixel; and
an adaptive size determining module configured to, based on a ratio relationship between a display object in the page to be displayed and the adaptive display unit, determine an adaptive size of the display object in the display interface, and render the display object in the page to be displayed based on the adaptive size of the display object.

In a third aspect, an embodiment of the present disclosure further provides an electronic device. The electronic device comprises:
at least one processor; and
a memory in communication with the at least one processor; wherein
the memory stores a computer program executable by the at least one processor, and the computer program, when executed by the at least one processor, enables the at least one processor to execute the display method according to any of the embodiments of the present disclosure.

In a fourth aspect, an embodiment of the present disclosure further provides a storage medium comprising computer executable instructions, wherein the storage medium stores computer instructions that, when executed by a processor, cause the processor to implement the display method according to any of the embodiments of the present disclosure.

### BRIEF DESCRIPTION OF THE DRAWINGS

Throughout the drawings, the same or similar reference numerals represent the same or similar components. It should be understood that the drawings are illustrative, and the elements and components are not necessarily drawn to scale.

FIG. 1 is a schematic flowchart of a display method provided by an embodiment of the present disclosure;

FIG. 2 is a schematic flowchart of a display method provided by an embodiment of the present disclosure;

FIG. 3 is a schematic structural diagram of a display interface provided by an embodiment of the present disclosure;

FIG. 4 is a schematic structural diagram of a display apparatus provided by an embodiment of the present disclosure;

FIG. 5 is a schematic structural diagram of an electronic device provided by an embodiment of the present disclosure.

### DETAILED DESCRIPTION OF EMBODIMENTS

It should be understood that the multiple steps described in the method implementations of the present disclosure may be performed in different orders and/or in parallel. In addition, the method implementations may include additional steps and/or omit the execution of the illustrated steps. The scope of the present disclosure is not limited in this respect.

The term “comprising” and its variations are used herein in an open-ended manner, meaning “including but not limited to”. The term “based on” is “at least partially based on”. The term “an embodiment” means “at least one embodiment”; the term “another embodiment” means “at least one additional embodiment”; and the term “some embodiments” means “at least some embodiments”. Related definitions of other terms will be given in the following description.

It should be noted that the concepts of “first”, “second” and the like mentioned in the present disclosure are only used to differentiate different devices, modules or units, and are not intended to limit the order or interdependence of the functions performed by these devices, modules or units.

It should be noted that the modifiers “a”, “an” and “multiple” as mentioned in the present disclosure are illustrative rather than limiting. Those skilled in the art should understand that unless explicitly stated otherwise in the context, they should be understood as “one or more”.

The names of the messages or information exchanged between the multiple devices in the embodiments of the present disclosure are for illustrative purposes only and are not intended to limit the scope of these messages or information.

It should be understood that before using the technical solutions disclosed in multiple embodiments of the present disclosure, the type, scope of use, and usage scenarios of the personal information involved in the present disclosure should be informed to the user and the user's authorization should be obtained in an appropriate manner in accordance with relevant laws and regulations.

For example, in response to receiving an active request from a user, a prompt message is sent to the user to clearly notify the user that the operation requested to be performed will require the acquisition and use of the user's personal information. Thus, the user may autonomously choose whether to provide personal information to software or hardware such as an electronic device, application, server, or storage medium that performs the operation of the technical solution of the present disclosure, according to the prompt message.

As an exemplary implementation, in response to receiving a user's active request, the manner of sending prompt information to the user may be, for example, a pop-up window, in which the prompt information may be presented in text. In addition, the pop-up window may also carry a selection control for the user to choose “agree” or “disagree” to provide personal information to the electronic device.

It should be understood that the above process of notifying and obtaining user authorization are only illustrative and do not constitute a limitation on the implementation of the present disclosure. Other manners that comply with relevant laws and regulations may also be applied to the implementations of the present disclosure.

It should be understood that the data involved in this technical solution (including but not limited to the data itself, the acquisition or use of the data) should comply with the requirements of relevant laws, regulations and relevant provisions.

For the same page to be displayed, when it is displayed in the display interfaces of different devices, the screen sizes of different devices are different, and accordingly, the display interface sizes of different devices are also different. In order to adapt the display page to the display interface, the display objects in the page to be displayed need to be scaled based on the interface size of the display interface in the current device. If the display object in the page to be displayed is not compatible with the page to be displayed during the scaling of the page to be displayed, i.e., the display object is not scaled along with the page to be displayed, the coordination of the interface display will be reduced, thereby reducing the comfort of the user's experience with respect to the corresponding page. In order to improve the adaptability of the display object with respect to the page to be displayed during the display by different devices, the technical solution of the embodiments of the present disclosure determines the adaptive display unit in the display interface of different devices respectively, and determines the adaptive size of the display object in different devices based on the ratio relationship between the display object in the interface to be displayed and the adaptive display unit in the display interface, so that when the display page obtained by rendering the display object based on the adaptive size is displayed in different devices, the adaptability of the display page and the display object is improved, thereby improving the comfort of the user's experience when operating the display page.

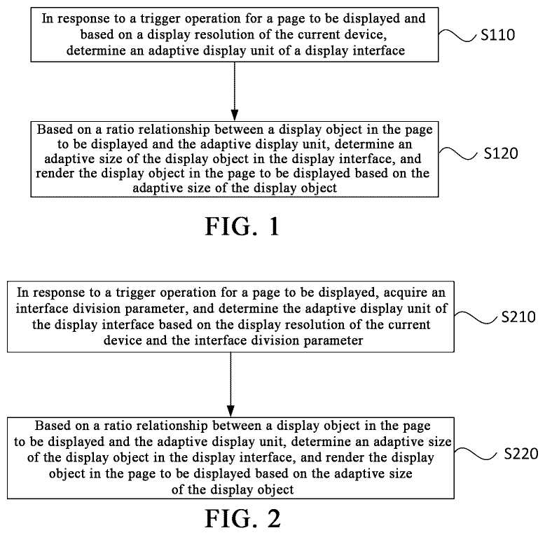

FIG. 1 is a schematic flowchart of a display method provided by an embodiment of the present disclosure. The embodiment of the present disclosure is applicable to situations in which interface design and production are performed on display interfaces displayed on different terminals. The method may be executed by a display apparatus, and the display apparatus may be implemented in the form of software and/or hardware, for example, by an electronic device, which may be a mobile terminal, a PC or a server, etc.

As shown in FIG. 1, the method comprises:
S110, determining, in response to a trigger operation for a page to be displayed and based on a display resolution of the current device, an adaptive display unit of a display interface; and
S120, determining, based on a ratio relationship between a display object in the page to be displayed and the adaptive display unit, an adaptive size of the display object in the display interface, and rendering the display object in the page to be displayed based on the adaptive size of the display object.

In the embodiments of the present disclosure, the current device may be understood as an electronic device equipped with a display screen, i.e., a device that can display pages through a display interface. The current device may include, but is not limited to, devices such as smart phones, tablets, televisions, and displays connected to computers, and the device model of the device is not limited. The display resolution may be understood as the display size for characterizing the display interface when displaying content. Usually, the display resolution may be denoted in pixels. For example, the display resolution of the current device may be understood as the number of pixels contained in any display page when the page is displayed on the display interface of the current device. For example, the number of pixels (display resolution) may be determined based on the product of the row pixels and the column pixels in the page. For example, the representation of the display resolution may include 375 px*812 px. It can be understood that different models of electronic devices may correspond to different display resolutions. For any application or search engine, its display page is displayed in the display interfaces of different electronic devices, that is, any display page is displayed on the display interfaces of different display resolutions. When a display page is displayed on a display interface with a high display resolution, the display page contains more pixels and displays more content. Conversely, when a display page is displayed on a display interface with a low display resolution, the display page contains fewer pixels and displays less content, which means that the same display page cannot achieve visual uniformity when displayed on different models of electronic devices.

The display interface can be understood as the screen interface used by the current device to display the display page. For example, the display interface may display pages including images, text, animations, controls, display areas, etc., such as any page in the application, the page of the search engine, etc., i.e., the page to be displayed. For example, the trigger operation for the page to be displayed may be a trigger operation for the application to which the page to be displayed belongs, such as a click operation on the application, or, after entering the application, a page switching operation, which may be a trigger operation of a control that links to the next page, or a gesture operation that links to the next page, etc., wherein the next page is the page to be displayed. In response to the trigger operation for the page to be displayed, the adaptive size of the display object in the page to be displayed in the display interface of the current device is determined to adapt and display the page to be displayed. By adapting and displaying on electronic devices of different models, it is compatible with electronic devices of different models to achieve visual uniformity of the display page.

The adaptive display unit may be used as a size measurement unit for displaying the display object in the page to be displayed in the display interface of each model of electronic device. The adaptive display units corresponding to different models of electronic devices may be different, and matches the display resolutions of the electronic devices. In each electronic device, the object size of the display object in the page to be displayed may be determined based on the adaptive display unit of the electronic device, so that the rendered display object is adapted to the display interface of the electronic device when displayed in the display interface.

For example, the size and layout of the display object of the page to be displayed in the display interface may be adjusted based on the adaptive display unit, to obtain the adaptive size of the display object when displayed in the display interface.

For example, acquiring the display resolution of the current device may include determining the corresponding attribute information based on the device type of the current device and reading the attribute information of the current device to obtain the display resolution of the current device. It may also be obtained by other means, which is not limited herein.

On this basis, the technical solution of this embodiment may determine the adaptive display unit in the display interface of the current device based on the display resolution. For example, a preset interface division parameter may be acquired, and the display resolution may be divided into units based on the interface division parameter to obtain the adaptive display unit in the display interface of the current device. Exemplarily, the interface division parameter may be the number of divisions of the display unit. Therein, of course, the adaptive display unit may also be determined by other means, which is not limited herein. In some embodiments, in the same electronic device, the interface division parameters corresponding to different display pages may be the same or different, and accordingly, the adaptive display units in the determined display interface may be the same or different. For example, the interface division parameters corresponding to the display pages in the same application are the same, and they are different from the interface division parameters corresponding to other applications, which means that the corresponding interface division parameters may be called according to the application to which the page to be displayed belongs, to determine the corresponding adaptive display unit. In some embodiments, different types of electronic devices, such as mobile phones, tablet computers, and laptop computers, may display different layouts for the same application, that is, different types of electronic devices may be set with different interface division parameters for the same application, which means that, according to the application to which the page to be displayed belongs and the type of electronic device, the corresponding interface division parameters may be called to determine the corresponding adaptive display unit.

In this embodiment, the page to be displayed can be understood as a display page to be rendered, and the display objects contained in the page to be displayed and the interface to be displayed are laid out to ensure the coordination of the page to be displayed when displayed on the display interfaces of different devices. For example, the page to be displayed may include but is not limited to an opening page of an application on a smart terminal and a web page of an application on a PC. The display object may include controls, text, pictures, and animated videos displayed in the page to be displayed. For example, if the page to be displayed is a recommendation page of a certain music application, correspondingly, the display objects include but are not limited to a list of recommended playlists, images of recommended songs, and operation controls for playing or other operations on the selected songs.

For example, in the process of rendering the page to be displayed, based on the ratio relationship between the display object in the page to be displayed and the above-determined adaptive display unit, the adaptive size of the display object when displayed on the display interface of the current device is determined, and the rendering is performed based on the adaptive size of the display object, to achieve the rendering of the page to be displayed. Therein, the page to be displayed may include multiple display objects.

For example, in a case that the page to be displayed is triggered, the data of the page to be displayed is acquired. The data of the page to be displayed may include rendering data of multiple display objects, as well as the ratio relationship between the display object and the adaptive display unit. For example, based on the above-mentioned implementation, the ratio relationships between the display objects and the adaptive display unit in the page to be displayed are determined respectively, and then the adaptive sizes of the display objects in the display interface of the current device are determined based on the ratio relationships between the display objects and the adaptive display unit, so that the display objects obtained by rendering based on the adaptive sizes of the display objects are more adapted to the page to be displayed.

For example, the adaptive display unit comprises at least one pixel. In some embodiments, the adaptive display unit may be a rectangle, including at least one pixel in each row and column. For example, the number of pixels corresponding to the display unit in rows and columns, i.e., the adaptive size in the display interface, may be determined according to the ratio relationship between the display object and the adaptive display unit. The adaptive size may include row size and column size, and the row size and column size may include the number of pixels respectively. The rendering of the page to be displayed is realized by rendering the display objects in the page to be displayed.

For example, before rendering the display object, it also includes determining the rendering position of the display object based on the positional relationship between the display objects and the adaptive size of the display object, and rendering the display object based on the rendering position and adaptive size of the display object. Since the interface sizes of the display interfaces of different display apparatuses are different, the adaptive sizes of the display objects are also different. By determining the rendering position of the display object, the rationality of rendering the display object is realized, and the unreasonable distribution of the display object is avoided.

The technical solution of the embodiments of the present disclosure, by determining the adaptive display unit in the display interface of the current device, and based on the ratio relationship between the display object in the interface to be displayed and the adaptive display unit, determines the adaptive size of the display object in the current device, so that when the display page obtained by rendering the display object based on the adaptive size is displayed in different devices, the display page and the display object have high adaptability, avoiding the low adaptation efficiency of the page on different terminal products in the related technology, improving the compatibility of the page in the design and production process, and the coordination when displayed on different terminals, and improving the adaptation efficiency of the interface on different terminal products, thereby improving the comfort of the user's experience when operating the display page.

FIG. 2 is a schematic flowchart of another display method provided by an embodiment of the present disclosure. This embodiment is based on the technical solution of any example in the embodiments of the present disclosure. For example, determining, based on the display resolution of the current device, the adaptive display unit of the display interface comprises: acquiring an interface division parameter, and determining the adaptive display unit of the display interface based on the display resolution of the current device and the interface division parameter. Therein, the explanation of the same or corresponding terms as in the above embodiment will not be repeated here. Referring to FIG. 2, the display method provided by this embodiment comprises:
S210, acquiring, in response to a trigger operation for a page to be displayed, an interface division parameter, and determining the adaptive display unit of the display interface based on the display resolution of the current device and the interface division parameter; and
S220, determining, based on a ratio relationship between a display object in the page to be displayed and the adaptive display unit, an adaptive size of the display object in the display interface, and rendering the display object in the page to be displayed based on the adaptive size of the display object.

Therein, the interface division parameter may include the number of divisions of the display unit. For example, the interface division parameter includes a row division parameter and/or a column division parameter, which means that, the interface division parameter may include the number of row divisions and/or the number of column divisions. The display resolution of the current device may be divided by the row division parameter and/or the column division parameter, to obtain the corresponding row size and/or column size, i.e., the size of the adaptive display unit.

For example, the method of determining the adaptive display unit of the display interface based on the display resolution of the current device and the interface division parameter comprises: determining a column size of the adaptive display unit based on a column resolution in the display resolution of the current device and the column division parameter; and/or, determining a row size of the adaptive display unit based on a row resolution in the display resolution of the current device and the row division parameter.

For example, the above-mentioned column resolution may be divided by the column division parameter to obtain the column size of the adaptive display unit. The above-mentioned row resolution may be divided by the row division parameter to obtain the row size of the adaptive display unit.

It should be noted that the unit shape of the adaptive display unit is determined in advance, and the row size and/or column size of the adaptive display unit are acquired according to the unit shape, so as to determine the adaptive display unit. For example, if the unit shape of the adaptive display unit is a square, the adaptive display unit may be determined only by determining the column size or row size of the adaptive display unit, which means that, the adaptive display unit may be a square with the column size as the side length, or a square with the row size as the side length. If the unit shape of the adaptive display unit is a rectangle, the adaptive display unit may only be determined when the row size and column size of the adaptive display unit are determined at the same time.

Based on the above implementation, the interface division parameter in this embodiment further comprises a boundary size parameter. Accordingly, in this embodiment, the method of determining the adaptive display unit of the display interface based on the display resolution of the current device and the interface division parameter further comprises: determining a target resolution of a display area based on the display resolution of the current device and the boundary size parameter; and determining the adaptive display unit of the display interface based on the column division parameter and/or the row division parameter, as well as the target resolution.

Therein, the boundary size parameter can be understood as the boundary resolution in the display interface of the current device. For example, in order to make the page to be displayed more beautiful and adaptable when displayed in the display interface of the current device, the present embodiment presets the boundary resolution when generating the page to be displayed which is displayed by the current device. For example, the boundary resolution may include one or more of the upper boundary resolution, the lower boundary resolution, the left boundary resolution, and the right boundary resolution.

On this basis, the target resolution may include a target row resolution and a target column resolution. For example, the target row resolution of the target resolution is determined based on the row resolution in the display resolution and the upper boundary resolution and/or the lower boundary resolution in the boundary size parameter; and then the row size of the adaptive display unit of the display interface is determined based on the target row resolution and the row division parameter. For example, the target column resolution of the target resolution is determined based on the column resolution in the display resolution and the upper boundary resolution and/or the lower boundary resolution in the boundary size parameter; and then the column size of the adaptive display unit of the display interface is determined based on the target column resolution and the column division parameter.

For the convenience of calculation, before determining the ratio relationship between the adaptive display unit and the display object, it is necessary to predetermine whether the size of the adaptive display unit is an integer. For example, in a case that the size of the adaptive display unit is not an integer, the column size or the row size is rounded. The specific size of the adaptive display unit includes the column size or the row size.

For example, the manner of rounding processing in this embodiment may be rounding up or rounding down. In order to ensure consistency in the processing process, a rounding threshold may be preset. If the decimal portion of the row size or column size is greater than the threshold, it will be rounded up. Otherwise, if it is less than the threshold, it will be rounded down.

Exemplarily, taking the case where the row size is not an integer as an example. If it is determined that the row size of the adaptive display unit of the display interface in the current device is 4.3 px, the value of its decimal portion is 0.3, which is less than the preset rounding threshold of 0.5, the row size is rounded down to obtain a final row size of 4 px. Otherwise, if it is determined that the row size of the adaptive display unit of the display interface in the current device is 3.8 px, the value of its decimal portion is 0.8, which is greater than the preset rounding threshold of 0.5, the row size is rounded up to obtain a final row size of 4 px.

Therein, the ratio relationship comprises a row ratio relationship and/or a column ratio relationship. Accordingly, in this embodiment, the method of determining, based on the ratio relationship between the display object in the page to be displayed and the adaptive display unit, the adaptive size of the display object in the display interface may comprise: determining, based on a column ratio relationship between a base column size of the display object and the adaptive display unit, and a column size of the adaptive display unit, an adaptive column size of the display object in the display interface, and determining a corresponding adaptive row size based on the adaptive column size, wherein the adaptive row size may be the same as the adaptive column size, or the adaptive row size may be proportional to the adaptive column size, and there is no limitation on this; or
determining, based on a row ratio relationship between a base row size of the display object and the adaptive display unit, and a row size of the adaptive display unit, an adaptive row size of the display object in the display interface, and determining a corresponding adaptive column size based on the adaptive row size, wherein the adaptive row size may be the same as the adaptive column size, or the adaptive column size may be proportional to the adaptive row size, and there is no limitation on this; or
determining, based on the row ratio relationship between the base row size of the display object and the adaptive display unit, and the row size of the adaptive display unit, the adaptive row size of the display object in the display interface, and, determining, based on the column ratio relationship between the base column size of the display object and the adaptive display unit, and the column size of the adaptive display unit, the adaptive column size of the display object in the display interface.

For example, the column size of the adaptive display unit and the column ratio relationship between the base column size of the display object and the adaptive display unit may be multiplied to obtain and determine the adaptive column size of the display object in the display interface. For example, the row size of the adaptive display unit and the row ratio relationship between the base row size of the display object and the adaptive display unit are multiplied to obtain and determine the adaptive row size of the display object in the display interface.

It should be noted that if the object shape of the display object is a square, the display object can be determined in a case that the adaptive column size or the adaptive row size of the display object is determined. If the object shape of the display object is a rectangle, it needs to determine the adaptive row size and the adaptive column size of the display object at the same time to determine the display object.

The technical solution of the embodiments of the present disclosure determines the adaptive display unit in the display interface of the current device by acquiring the display resolution in the display interface of the current device and display division parameters, and determines the adaptive size of the display object in the current device based on the ratio relationship between the display object in the interface to be displayed and the adaptive display unit, so that when the display page obtained by rendering the display object based on the adaptive size is displayed in different devices, the display page and the display object have high adaptability, avoiding the low adaptation efficiency of the page on different terminal products in the related technology, improving the compatibility of the page in the design and production process, and the coordination when displayed on different terminals, thereby improving the adaptation efficiency of the interface on different terminal products.

Based on the above embodiment, the interface division parameters may be determined based on the base resolution of the test device for displaying the page to be displayed. Therein, the test device can be understood as an electronic device for developing and testing the page to be displayed. For example, it may be an electronic device for developing and testing the application to which the page to be displayed belongs, which can be set according to user needs, and the model of the test device is not limited here. For example, the test device may be any type and any model of electronic device. The base resolution can be understood as the resolution of the display interface of the test device, which may be determined based on the device properties.

For example, based on the determination of the test device, the interface division parameters in this embodiment may be determined by: determining the interface division parameters based on the base resolution of the test device and the display unit size of the test device.

Therein, the display unit size in the test device may be a preset display unit size, such as a unit row size and a unit column size. For example, the unit shape of the display unit may include a square, a rectangle, etc., which is not limited herein.

For example, taking the unit shape of the display unit as a rectangle as an example, determining the interface division parameter comprises: acquiring the row base resolution of the base resolution of the test device, and acquiring the row unit size in the display unit size, and then dividing the row base resolution by the row unit size to obtain the row division parameter of the interface division parameter. For example, the column base resolution of the base resolution of the test device is acquired, and the column unit size in the display unit size is acquired, so as to divide the column base resolution by the column display unit size to obtain the column division parameter of the interface division parameter.

For example, the display resolution in the display interface of the current device determined above is divided by the acquired interface division parameter in the display interface of the current device, to obtain the adaptive display unit in the display interface of the current device.

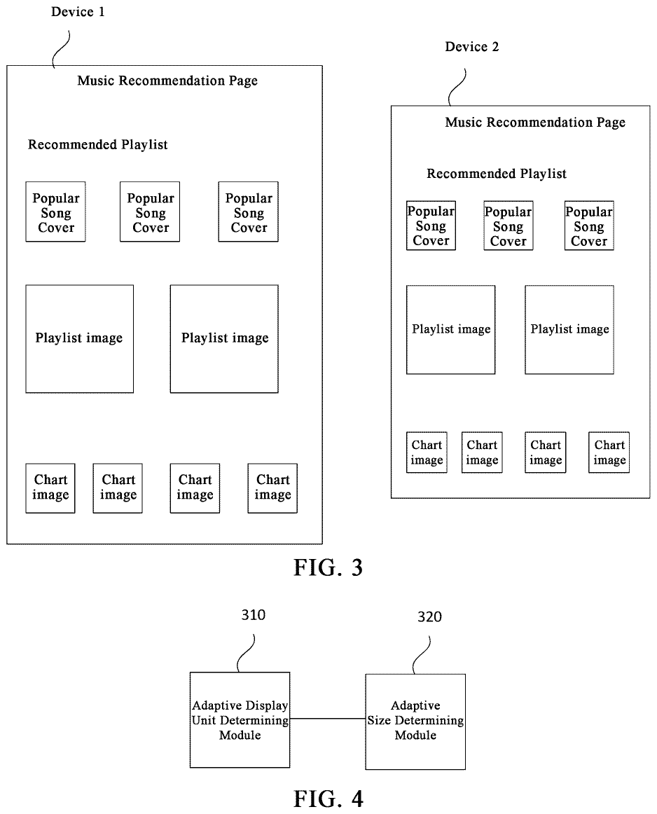

Based on the above embodiments, the present disclosure also provides an exemplary implementation. FIG. 3 is a schematic diagram of an exemplary embodiment of the above display method provided by an embodiment of the present disclosure. The exemplary embodiment is shown in FIG. 3, which includes a page to be displayed rendered by device 1 as well as the display objects included therein, and a page to be displayed rendered by device 2 as well as the display objects included therein. In this embodiment, the display resolutions of the display interfaces of device 1 and device 2 are different.

For example, in the process of designing and producing a page to be displayed, for example, taking the page to be displayed as a music recommendation page as an example, the display objects in the corresponding page to be displayed include but are not limited to identifying texts such as a recommended playlist, playlist images, popular song covers, and chart images. When the page to be displayed is displayed in device 1, the display resolution of the device screen is acquired as 375 px*812 px. Since the processing manners of rows and columns are the same, this implementation only takes columns as an example to illustrate the subsequent solution. For example, the left and right boundary resolutions of 16 px+15 px are reserved on both sides of the display screen of device 1, and the target column resolution of the remaining core display area is 344 px. For example, the interface division parameters obtained in advance based on the test device, i.e., the maximum number of interface unit divisions, such as the column division parameter 86 columns in the interface division parameters, are acquired, and the column size 4 px of the adaptive display unit is obtained based on the above target column resolution and the column division parameters.

Based on the ratio relationship between the column size of the display object and the column size of the adaptive display unit, and the column size of the adaptive display unit, the column size of the display object may be determined. If Y represents the column size of the adaptive display unit, the column size of the playlist image may be denoted as 4 px*36, the column size of the popular song cover may be denoted as 4 px*20, the column size of the chart image may be denoted as 4 px*12, and the column size of the recommended playlist identifying text may be denoted as 4 px*24.

When the page to be displayed is displayed in device 2, the display resolution of its device screen is acquired as 320 px*568 px. For example, the left and right boundary resolutions of 12 px+10 px are reserved on both sides of the display screen of device 2, and the target column resolution of the remaining core display area is 298 px. For example, the interface division parameter obtained in advance based on the test device, i.e., the maximum number of interface unit divisions, such as the column division parameter 86 columns in the interface division parameter, is acquired, and the column size of the adaptive display unit is 3.46 px based on the above target column resolution and column division parameter. In order to facilitate subsequent calculations, the column size of the adaptive display unit is rounded down, and the final column size of the adaptive display unit is 3 px. For example, based on the ratio relationship between the column size of the display object and the column size of the adaptive display unit, as well as the column size of the adaptive display unit, the column size of the display object may be determined. If X represents the column size of the adaptive display unit, the column size of the playlist image may be denoted as 3 px*36, the column size of the popular song cover may be denoted as 3 px*20, the column size of the chart image may be denoted as 3 px*12, and the column size of the recommended playlist identifying text may be denoted as 3 px*24.

Through the above technical solution, the situation of low adaptation efficiency of the page on different terminal products is avoided, the compatibility of the page in the design and production process is improved, and the coordination when displayed on different terminals is improved, thereby improving the adaptation efficiency of the interface on different terminal products.

FIG. 4 is a schematic structural diagram of a display apparatus provided by an embodiment of the present disclosure. As shown in FIG. 4, the apparatus comprises an adaptive display unit determining module 310 and an adaptive size determining module 320.

The adaptive display unit determining module 310 is configured to determine, based on a display resolution of the current device, an adaptive display unit of a display interface.

The adaptive size determining module 320 is configured to determine, based on a ratio relationship between a display object in the page to be displayed and the adaptive display unit, an adaptive size of the display object in the display interface, and render the display object in the page to be displayed based on the adaptive size of the display object.

The technical solution of the embodiments of the present disclosure, by determining the adaptive display unit in the display interface of the current device, and based on the ratio relationship between the display object in the interface to be displayed and the adaptive display unit, determines the adaptive size of the display object in the current device, so that when the display page obtained by rendering the display object based on the adaptive size is displayed in different devices, the display page and the display object have high adaptability, thus avoiding the low adaptation efficiency of the page on different terminal products in the related technology, improving the compatibility of the page in the design and production process, and the coordination when displayed on different terminals, and improving the adaptation efficiency of the interface on different terminal products, thereby improving the comfort of the user's experience when operating the display page.

Based on the above implementation, the adaptive display unit determining module 310 comprises:
an adaptive display unit determining sub-module, configured to acquire interface division parameter and determine the adaptive display unit of the display interface based on the display resolution of the current device and the interface division parameters.

Based on the above implementation, the interface division parameter comprises a column division parameter and/or a row division parameter.

The adaptive display unit determining sub-module comprises:

a column size determining unit, configured to determine the column size of the adaptive display unit based on the column resolution in the display resolution of the current device and the column division parameter; and/or,
a row size determining unit, configured to determine the row size of the adaptive display unit based on the row resolution in the display resolution of the current device and the row division parameter.

Based on the above implementation, the apparatus comprises:
a size rounding processing module, configured to round the column size or row size in a case that the column size or row size is not an integer.

Based on the above implementation, the interface division parameter further comprises a boundary size parameter.

The adaptive display unit determining sub-module comprises:
a target resolution determining unit, configured to determine the target resolution of the display area based on the display resolution of the current device and the boundary size parameter; and
an adaptive display unit determining unit, configured to determine the adaptive display unit of the display interface based on the column division parameter and/or row division parameter and the target resolution.

Based on the above implementation, the ratio relationship comprises a row ratio relationship and/or a column ratio relationship; based on a column ratio relationship between a base column size of the display object and the adaptive display unit, and a column size of the adaptive display unit, an adaptive column size of the display object in the display interface is determined.

Alternatively, the adaptive size determining module 320 comprises:
a first adaptation size determining sub-module, configured to determine, based on a column ratio relationship between a base column size of the display object and the adaptive display unit, and a column size of the adaptive display unit, an adaptive column size of the display object in the display interface, and determine a corresponding adaptive row size based on the adaptive column size; or,
a second adaptation size determining sub-module, configured to determine, based on a row ratio relationship between a base row size of the display object and the adaptive display unit, and a row size of the adaptive display unit, an adaptive row size of the display object in the display interface, and determine a corresponding adaptive column size based on the adaptive row size; or,
a third adaptation size determining sub-module, configured to determine, based on the row ratio relationship between the base row size of the display object and the adaptive display unit, and the row size of the adaptive display unit, the adaptive row size of the display object in the display interface, and, determine, based on the column ratio relationship between the base column size of the display object and the adaptive display unit, and the column size of the adaptive display unit, the adaptive column size of the display object in the display interface.

Based on the above implementation, the interface division parameter is determined based on the base resolution of the test device of the page to be displayed.

The Adaptive Display Unit Determining Sub-Module Comprises:
an interface division parameter determining unit, configured to determine the interface division parameter based on the base resolution of the test device and the display unit size in the test device.

The display apparatus provided in the embodiment of the present disclosure can execute the display method provided in any of the embodiments of the present disclosure, and has the corresponding functional modules for executing the method and has beneficial effects.

It should be noted that the multiple units and modules included in the above device are only divided according to functional logic, but are not limited to the above division, as long as the corresponding functions can be realized. In addition, the specific names of the multiple functional units are only for the convenience of distinguishing each other, and are not intended to limit the protection scope of the embodiments of the present disclosure.

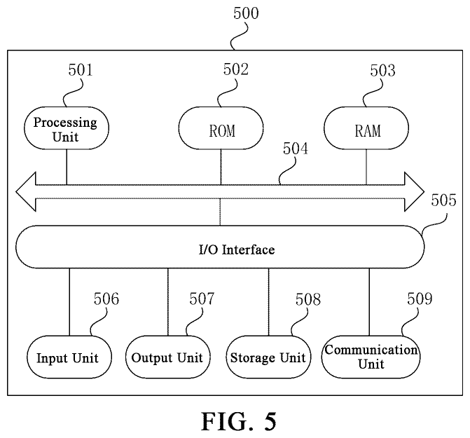

FIG. 5 is a schematic structural diagram of an electronic device provided by an embodiment of the present disclosure. Referring to FIG. 5 below, it shows a schematic structural diagram of an electronic device (such as a terminal device or server in FIG. 5) 500 suitable for implementing the embodiments of the present disclosure. The terminal devices in the embodiments of the present disclosure may include but are not limited to mobile terminals such as mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 5 is only an example and should not impose any restrictions on the functions and scope of use of the embodiments of the present disclosure.

As shown in FIG. 5, the electronic device 500 may include a processing unit (such as a central processing unit, a graphics processor, etc.) 501, which can perform a variety of appropriate actions and processes according to a program stored in a read-only memory (ROM) 502 or a program loaded from a storage unit 508 to a random access memory (RAM) 503. In RAM 503, a variety of programs and data required for the operation of the electronic device 500 are also stored. The processing unit 501, ROM 502, and RAM 503 are connected to each other via a bus 504. An input/output (I/O) interface 505 is also connected to the bus 504.

Typically, the following unit may be connected to the I/O interface 505: input unit 506 such as, for example, a touch screen, touchpad, keyboard, mouse, camera, microphone, accelerometer, gyroscope, etc.; output unit 507 such as, for example, a liquid crystal display (LCD), speaker, vibrator, etc.; storage unit 508 such as, for example, a magnetic tape, hard disk, etc.; and communication unit 509. The communication unit 509 may allow the electronic device 500 to engage in wireless or wired communication with other devices to exchange data. Although FIG. 5 illustrates electronic device 500 having various unit, it should be understood that it is not required to implement or include all the units shown. Alternatively, more or fewer units may be implemented or included.

According to an embodiment of the present disclosure, the process described above with reference to the flowchart may be implemented as a computer software program. For example, an embodiment of the present disclosure comprises a computer program product including a computer program carried on a non-transitory computer-readable medium, the computer program including a program code for executing the method shown in the flowchart. In such an embodiment, the computer program may be downloaded and installed from the network through the communication unit 509, or installed from the storage unit 508, or installed from the ROM 502. When the computer program is executed by the processing unit 501, the above functions defined in the method of the embodiment of the present disclosure are executed.

The names of the messages or information exchanged between the multiple devices in the embodiments of the present disclosure are for illustrative purposes only and are not intended to limit the scope of these messages or information.

The electronic device provided by the embodiment of the present disclosure belongs to the same concept as the display method provided by the above embodiment. The technical details not described in detail in this embodiment can be referred to the above embodiment, and this embodiment has the same beneficial effects as the above embodiment.

An embodiment of the present disclosure provides a computer storage medium, on which a computer program is stored, and the program implements the display method provided by the above embodiment when executed by the processor.

It should be noted that the computer-readable medium described above in the present disclosure may be a computer-readable signal medium, a computer-readable storage medium, or any combination of the two above. The computer-readable storage medium may be, but is not limited to, an electrical, magnetic, optical, electromagnetic, infrared, or semiconductor system, apparatus, or device, or any combination thereof. More specific examples of computer-readable storage media may include, but are not limited to: electrical connections having one or more wires, portable computer disks, hard disks, random access memory (RAM), read-only memory (ROM), erasable programmable read-only memory (EPROM or flash memory), fiber optics, portable compact disk read-only memory (CD-ROM), optical storage unit, magnetic storage unit, or any suitable combination of the above. In the present disclosure, a computer-readable storage medium may be any tangible medium that contains or stores a program that can be used by or in combination with an instruction execution system, apparatus, or device. In the present disclosure, a computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. A computer-readable signal medium that may also be any computer-readable medium other than a computer-readable storage medium can transmit, propagate, or convey a program for use by or in combination with an instruction execution system, apparatus, or device. The program code contained on a computer-readable medium may be transmitted by any suitable medium, including but not limited to electrical wiring, optical cables, RF (radio frequency), and any suitable combination of the above.

In some embodiments, the client and the server may communicate using any currently known or future developed network protocol such as HTTP (HyperText Transfer Protocol), and may be interconnected with any form or medium of digital data communication (e.g., communication network). Examples of communication networks include local area networks (“LAN”), wide area networks (“WAN”), internets (e.g., the Internet), and peer-to-peer networks (e.g., ad hoc peer-to-peer networks), as well as any currently known or future developed networks.

The above-mentioned computer-readable medium may be contained in the above-mentioned electronic device; or it may exist separately without being assembled into the electronic device.

The computer-readable medium carries one or more programs. When the one or more programs are executed by the electronic device, the electronic device:

The computer-readable medium carries one or more programs. When the one or more programs are executed by the electronic device, the electronic device: determines the adaptive display unit of the display interface based on the display resolution of the current device; and
determines the adaptive size of the display object in the display interface based on the ratio relationship between the display object in the page to be displayed and the adaptive display unit, and renders the display object in the page to be displayed based on the adaptive size of the display object.

The computer program code for performing the operations of the present disclosure may be written in one or more programming languages or a combination thereof, including but not limited to object-oriented programming languages such as Java, Smalltalk, C++, as well as conventional procedural programming languages such as the “C” language or similar programming languages. The program code may execute entirely on the user's computer, partially on the user's computer, as a standalone software package, partially on the user's computer and partially on a remote computer, or entirely on a remote computer or server. In the case of remote computers, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the possible implementation architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing the specified logical functions. It should also be noted that in some alternative implementations, the functions indicated in the box may also occur in an order different from that indicated in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, may be implemented by a dedicated hardware-based system that performs the specified function or operation, or may be implemented by a combination of dedicated hardware and computer instructions.

The units involved in the embodiments described in the present disclosure may be implemented by software or by hardware. Therein, the name of the unit does not constitute a limitation on the unit itself in some cases. For example, the first acquisition unit may also be described as “a unit for acquiring at least two Internet Protocol addresses”.

The functions described above herein may be at least partially performed by one or more hardware logic components. For example, without limitation, exemplary types of hardware logic components that may be used include: field programmable gate arrays (FPGA), application-specific integrated circuits (ASIC), application-specific standard products (ASSP), system on a chip (SOC), complex programmable logic devices (CPLD), etc.

In the context of the present disclosure, a machine-readable medium may be a tangible medium that can contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the above. More specific examples of machine-readable storage media may include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination of the above.

[In the section of DETAILED DESCRIPTION OF EMBODIMENTS, at the end of the entire text, please repeat all the contents to be protected in the form of claims in the following format:]

According to one or more embodiments of the present disclosure, [Example 1] provides a display method, comprising:
determining, in response to a trigger operation for a page to be displayed and based on a display resolution of a current device, an adaptive display unit of a display interface, the adaptive display unit comprising at least determining, based on a ratio relationship between a display object in the page to be displayed and the adaptive display unit, an adaptive size of the display object in the display interface, and rendering the display object in the page to be displayed based on the adaptive size of the display object.

According to one or more embodiments of the present disclosure, [Example 2] provides a display method, wherein determining, based on the display resolution of the current device, the adaptive display unit of the display interface comprises:
acquiring an interface division parameter, and determining the adaptive display unit of the display interface based on the display resolution of the current device and the interface division parameter.

According to one or more embodiments of the present disclosure, [Example 3] provides a display method, wherein the interface division parameter comprises a column division parameter and/or a row division parameter; and
wherein determining the adaptive display unit of the display interface based on the display resolution of the current device and the interface division parameter comprise:
determining a column size of the adaptive display unit based on a column resolution in the display resolution of the current device and the column division parameter; and/or,
determining a row size of the adaptive display unit based on a row resolution in the display resolution of the current device and the row division parameter.

According to one or more embodiments of the present disclosure, [Example 4] provides a display method, further comprising:
rounding the column size or the row size in a case that the column size or the row size is not an integer.

According to one or more embodiments of the present disclosure, [Example 5] provides a display method, wherein the interface division parameter further comprises a boundary size parameter; and
wherein determining the adaptive display unit of the display interface based on the display resolution of the current device and the interface division parameter comprises:
determining a target resolution of a display area based on the display resolution of the current device and the boundary size parameter; and
determining the adaptive display unit of the display interface based on the column division parameter and/or the row division parameter, as well as the target resolution.

According to one or more embodiments of the present disclosure, [Example 6] provides a display method, wherein the ratio relationship comprises a row ratio relationship and/or a column ratio relationship; and
wherein determining, based on the ratio relationship between the display object in the page to be displayed and the adaptive display unit, the adaptive size of the display object in the display interface comprises:
determining, based on a column ratio relationship between a base column size of the display object and the adaptive display unit, and a column size of the adaptive display unit, an adaptive column size of the display object in the display interface, and determining a corresponding adaptive row size based on the adaptive column size; or
determining, based on a row ratio relationship between a base row size of the display object and the adaptive display unit, and a row size of the adaptive display unit, an adaptive row size of the display object in the display interface, and determining a corresponding adaptive column size based on the adaptive row size; or
determining, based on the row ratio relationship between the base row size of the display object and the adaptive display unit, and the row size of the adaptive display unit, the adaptive row size of the display object in the display interface, and, determining, based on the column ratio relationship between the base column size of the display object and the adaptive display unit, and the column size of the adaptive display unit, the adaptive column size of the display object in the display interface.

According to one or more embodiments of the present disclosure, [Example 7] provides a display method, wherein the interface division parameter is determined based on a base resolution of a test device for the page to be displayed; and
wherein the interface division parameter is determined by:
determining the interface division parameter based on the base resolution of the test device and a display unit size of the test device.

According to one or more embodiments of the present disclosure, [Example 8] provides a display apparatus, comprising:
an adaptive display unit determining module configured to determine, in response to a trigger operation for a page to be displayed and based on a display resolution of the current device, an adaptive display unit of a display interface, the adaptive display unit comprising at least one pixel; and
an adaptive size determining module configured to determine, based on a ratio relationship between a display object in the page to be displayed and the adaptive display unit, an adaptive size of the display object in the display interface, and render the display object in the page to be displayed based on the adaptive size of the display object.

Additionally, although multiple operations are depicted in a particular order, this should not be construed as requiring such operations to be performed in the specific order illustrated, or in sequential order. In certain contexts, multitasking and parallel processing may be advantageous. Similarly, while certain specific implementation details are included in the foregoing discussion, these should not be construed as limiting the scope of the present disclosure. Certain features described in the context of separate embodiments may also be implemented in combination in a single embodiment. Conversely, various features described in the context of a single embodiment may also be implemented separately or in any suitable sub-combination in multiple embodiments.

1. A display method, comprising:
determining, in response to a trigger operation for a page to be displayed and based on a display resolution of a current device, an adaptive display unit of a display interface, the adaptive display unit comprising at least one pixel; and
determining, based on a ratio relationship between a display object in the page to be displayed and the adaptive display unit, an adaptive size of the display object in the display interface, and rendering the display object in the page to be displayed based on the adaptive size of the display object.

2. The method according to claim 1, wherein determining, based on the display resolution of the current device, the adaptive display unit of the display interface comprises:
acquiring an interface division parameter, and determining the adaptive display unit of the display interface based on the display resolution of the current device and the interface division parameter.

3. The method according to claim 2, wherein the interface division parameter comprises at least one of: a column division parameter, and a row division parameter; and
wherein determining the adaptive display unit of the display interface based on the display resolution of the current device and the interface division parameter comprises at least one of:
determining a column size of the adaptive display unit based on a column resolution in the display resolution of the current device and the column division parameter; or
determining a row size of the adaptive display unit based on a row resolution in the display resolution of the current device and the row division parameter.

4. The method according to claim 3, further comprising:
rounding the column size or the row size in a case that the column size or the row size is not an integer.

5. The method according to claim 3, wherein the interface division parameter further comprises a boundary size parameter; and
wherein determining the adaptive display unit of the display interface based on the display resolution of the current device and the interface division parameter comprises:
determining a target resolution of a display area based on the display resolution of the current device and the boundary size parameter; and
determining the adaptive display unit of the display interface based on the target resolution and at least one of the column division parameter and the row division parameter.

6. The method according to claim 1, wherein the ratio relationship comprises at least one of: a row ratio relationship, and a column ratio relationship; and
wherein determining, based on the ratio relationship between the display object in the page to be displayed and the adaptive display unit, the adaptive size of the display object in the display interface comprises at least one of:
determining, based on a column ratio relationship between a base column size of the display object and the adaptive display unit, and a column size of the adaptive display unit, an adaptive column size of the display object in the display interface, and determining a corresponding adaptive row size based on the adaptive column size;
determining, based on a row ratio relationship between a base row size of the display object and the adaptive display unit, and a row size of the adaptive display unit, an adaptive row size of the display object in the display interface, and determining a corresponding adaptive column size based on the adaptive row size; or
determining, based on the row ratio relationship between the base row size of the display object and the adaptive display unit, and the row size of the adaptive display unit, the adaptive row size of the display object in the display interface, and determining, based on the column ratio relationship between the base column size of the display object and the adaptive display unit, and the column size of the adaptive display unit, the adaptive column size of the display object in the display interface.

7. The method according to claim 2, wherein the interface division parameter is determined based on a base resolution of a test device for the page to be displayed; and
wherein the interface division parameter is determined by:
determining the interface division parameter based on the base resolution of the test device and a display unit size of the test device.

8. (canceled)

9. An electronic device, comprising:
one or more processors; and
a storage configured to store one or more programs,
wherein when the one or more programs are executed by the one or more processors, the one or more processors 7 is caused to:
determine, in response to a trigger operation for a page to be displayed and based on a display resolution of a current device, an adaptive display unit of a display interface, the adaptive display unit comprising at least one pixel; and
determine, based on a ratio relationship between a display object in the page to be displayed and the adaptive display unit, an adaptive size of the display object in the display interface, and render the display object in the page to be displayed based on the adaptive size of the display object.

10. A non-transitory storage medium comprising computer executable instructions, wherein the computer executable instructions, when executed by a computer processor, are used to:
determine, in response to a trigger operation for a page to be displayed and based on a display resolution of a current device, an adaptive display unit of a display interface, the adaptive display unit comprising at least one pixel; and
determine, based on a ratio relationship between a display object in the page to be displayed and the adaptive display unit, an adaptive size of the display object in the display interface, and render the display object in the page to be displayed based on the adaptive size of the display object.

11. The electronic device according to claim 9, wherein the one or more programs causing the one or more processors to determine, based on the display resolution of the current device, the adaptive display unit of the display interface further causes the one or more processors to:
acquire an interface division parameter, and determine the adaptive display unit of the display interface based on the display resolution of the current device and the interface division parameter.

12. The electronic device according to claim 11, wherein the interface division parameter comprises at least one of: a column division parameter, and a row division parameter; and
wherein the one or more programs causing the one or more processors to determine the adaptive display unit of the display interface based on the display resolution of the current device and the interface division parameter further causes the one or more processors at least to:
determine a column size of the adaptive display unit based on a column resolution in the display resolution of the current device and the column division parameter; or
determine a row size of the adaptive display unit based on a row resolution in the display resolution of the current device and the row division parameter.

13. The electronic device according to claim 12, wherein the one or more processors is further caused to:
round the column size or the row size in a case that the column size or the row size is not an integer.

14. The electronic device according to claim 12, wherein the interface division parameter further comprises a boundary size parameter; and
wherein the one or more programs causing the one or more processors to determine the adaptive display unit of the display interface based on the display resolution of the current device and the interface division parameter further causes the one or more processors to:
determine a target resolution of a display area based on the display resolution of the current device and the boundary size parameter; and
determine the adaptive display unit of the display interface based on the target resolution and at least one of the column division parameter and the row division parameter.

15. The electronic device according to claim 9, wherein the ratio relationship comprises at least one of: a row ratio relationship, and a column ratio relationship; and
wherein the one or more programs causing the one or more processors to determine, based on the ratio relationship between the display object in the page to be displayed and the adaptive display unit, the adaptive size of the display object in the display interface further causes the one or more processors at least to:
determine, based on a column ratio relationship between a base column size of the display object and the adaptive display unit, and a column size of the adaptive display unit, an adaptive column size of the display object in the display interface, and determine a corresponding adaptive row size based on the adaptive column size; or
determine, based on a row ratio relationship between a base row size of the display object and the adaptive display unit, and a row size of the adaptive display unit, an adaptive row size of the display object in the display interface, and determine a corresponding adaptive column size based on the adaptive row size; or
determine, based on the row ratio relationship between the base row size of the display object and the adaptive display unit, and the row size of the adaptive display unit, the adaptive row size of the display object in the display interface, and determine, based on the column ratio relationship between the base column size of the display object and the adaptive display unit, and the column size of the adaptive display unit, the adaptive column size of the display object in the display interface.

16. The electronic device according to claim 11, wherein the interface division parameter is determined based on a base resolution of a test device for the page to be displayed; and
wherein the one or more programs causing the one or more processors to determine the interface division parameter further causes the one or more processors to:
determine the interface division parameter based on the base resolution of the test device and a display unit size of the test device.

17. The non-transitory storage medium according to claim 10, wherein the computer executable instructions used to determine, based on the display resolution of the current device, the adaptive display unit of the display interface are further used to:
acquire an interface division parameter, and determine the adaptive display unit of the display interface based on the display resolution of the current device and the interface division parameter.

18. The non-transitory storage medium according to claim 17, wherein the interface division parameter comprises at least one of: a column division parameter, and a row division parameter; and
wherein the computer executable instructions used to determine the adaptive display unit of the display interface based on the display resolution of the current device and the interface division parameter are further used at least to:
determine a column size of the adaptive display unit based on a column resolution in the display resolution of the current device and the column division parameter; or
determine a row size of the adaptive display unit based on a row resolution in the display resolution of the current device and the row division parameter.

19. The non-transitory storage medium according to claim 18, wherein the computer executable instructions are further used to:
round the column size or the row size in a case that the column size or the row size is not an integer.

20. The non-transitory storage medium according to claim 18, wherein the interface division parameter further comprises a boundary size parameter; and
wherein the computer executable instructions used to determine the adaptive display unit of the display interface based on the display resolution of the current device and the interface division parameter are further used to:
determine a target resolution of a display area based on the display resolution of the current device and the boundary size parameter; and
determine the adaptive display unit of the display interface based on the target resolution and at least one of the column division parameter and the row division parameter.

21. The non-transitory storage medium according to claim 10, wherein the ratio relationship comprises at least one of: a row ratio relationship, and a column ratio relationship; and
wherein the computer executable instructions used to determine, based on the ratio relationship between the display object in the page to be displayed and the adaptive display unit, the adaptive size of the display object in the display interface are further at least used to:
determine, based on a column ratio relationship between a base column size of the display object and the adaptive display unit, and a column size of the adaptive display unit, an adaptive column size of the display object in the display interface, and determine a corresponding adaptive row size based on the adaptive column size; or
determine, based on a row ratio relationship between a base row size of the display object and the adaptive display unit, and a row size of the adaptive display unit, an adaptive row size of the display object in the display interface, and determine a corresponding adaptive column size based on the adaptive row size; or
determine, based on the row ratio relationship between the base row size of the display object and the adaptive display unit, and the row size of the adaptive display unit, the adaptive row size of the display object in the display interface, and determine, based on the column ratio relationship between the base column size of the display object and the adaptive display unit, and the column size of the adaptive display unit, the adaptive column size of the display object in the display interface.
